(19) United States
(12) Patent Application Publication
(10) Pub. No.: US 2021/0192652 A1
(43) Pub. Date: Jun. 24, 2021

(54) Platform, Method, and Apparatus for Litigation Management

(71) Applicant: Data Donate Technologies, Inc., New York, NY (US)

(72) Inventors: Alfred Blair Blaikie, III, Tinton Falls, NJ (US); Nathaniel T. Bradley, Colts Neck, NJ (US); Joshua S. Paugh, Tucson, AZ (US); Edward Braniff, III, Avon, NJ (US); Joseph Cammarata, Old Bridge Township, NJ (US)

(73) Assignee: Data Donate Technologies, Inc., New York, NY (US)

(21) Appl. No.: 17/132,984

(22) Filed: Dec. 23, 2020

Related U.S. Application Data
(60) Provisional application No. 62/953,276, filed on Dec. 24, 2019.

(51) Int. Cl. G06Q 50/18; G06Q 30/00; G06Q 20/12; G06Q 20/06; G06Q 10/10; G06Q 50/00; G06Q 50/26; G06F 16/245; G06F 16/23

(52) U.S. Cl. CPC G06Q 50/18; G06Q 30/018; G06Q 20/1235; G06Q 20/0655; G06Q 10/10; G06Q 2220/10; G06Q 50/01; G06Q 50/26; G06F 16/245; G06F 16/2365; G06Q 30/014

(57) ABSTRACT

A system, method, device, and data platform for managing a legal action. Purchase data for goods and services is received. The purchase data is automatically stored in a data platform. A notification and associated information regarding the legal action are received. The secure records of a data platform is automatically searched for users associated with the legal action utilizing the information. The user is notified of the legal action and one or more legal options in response to determine the user is associated with the legal action.

### BACKGROUND

### I. Field of the Disclosure

The illustrative embodiments relate to legal management. More specifically, but not exclusively, the illustrative embodiments relate to a network, system, method, apparatus, and platform for managing large scale litigation matters, governmental, financial, or legal issues.

### II. Description of the Art

There are various types of large-scale legal matters including class action lawsuits and mass tort litigation. In each situation, there is often are large number of plaintiffs represented in a large group or class that want to assert an injury, damage, or other grievance. The class or large group is often represented by class representatives that main include one or more associated groups of lawyers, law firms, experts, technical specialists, and other specialized parties. In one example, a class may require certification indicating that the court has determined that a class action is the best option to manage multiple claims. It is difficult to efficiently and cheaply find and communicate with all potentially relevant parties regarding the legal matter and their potential options. For example, users may be required to provide sales receipts, confirmation of purchase or service, or other information that may be from years earlier. Relevant parties may also miss notifications and alerts that are mailed, displayed in advertisements, newspapers, billboards, emails, or other communications by potentially deeming them insignificant, too complex to understand, or unsolicited communications (e.g., spam, junk mail, irrelevant advertisements, etc.). As a result, many potential plaintiffs may not be added as a party to the legal matter, compensated for potential damages, or informed of their potential legal rights. Existing solutions require expensive hourly rate employees (e.g., lawyers, paralegals, assistants, private investigators, experts, etc.) or class action litigation software that may also be difficult to use for so many potential users/clients.

### SUMMARY OF THE DISCLOSURE

The illustrative embodiments provide a system, method, device, and data platform for managing a legal action. Purchase data for goods and services are received. The purchase data is automatically stored in a data platform. A notification and associated information regarding the legal action are received. The secure records of a data platform are automatically searched for users associated with the legal action utilizing the information. The user is notified of the legal action and one or more legal options in response to determine the user is associated with the legal action. Another embodiment provides a data platform including a processor for executing a set of instructions and a memory for storing the set of instructions. The set of instructions are executed to perform the method herein described.

Another embodiment provides a system for managing a legal action. The system includes electronic devices executing a data application. The data application is configured to capture the transaction data associated with a user. The system also includes a data platform accessible by the electronic devices executing the data application through one or more networks. The data platform receives user purchase data for goods and services, automatically stores the purchase data as secure records in a data platform, receives a notification and associated information regarding the legal action, automatically searches the secure records of a data platform for users associated with the legal action utilizing the information, notifying the user of the legal action and one or more legal options in response to determining the user is associated with the legal action, and receiving additional information and selections from the user.

Alternative embodiments may provide a method for requesting additional information from the one or more users and receiving additional information from the one or more users. The additional information may include selections from a user for participating in the legal action. The method may further create one or more tokens based on the data type and value of purchase data, vend the purchase data to one of a number of parties utilizing one or more tokens, and compensate one or more parties for vending the purchase data. The user data may be accessible from the secure records utilizing an indicator including one or more tokens. Receiving the purchase data may include receiving one or more data elements initially and verifying the accuracy of the one or more data elements. The purchase data may be utilized according to a user profile associated with each of the one or more users. The transaction data may be accessible utilizing an indicator associated with the cryptocurrency tokens. A smart contract may be created controlling utilization of the user data to perform the legal action. The legal action may be managed utilizing the data platform. The data platform may distribute compensation to the user in response to a verdict. The compensation may include free products or services, discounts, refunds, cash/checks, cryptocurrency, and/or coupons. Communications associated with the legal action may be performed through the data platform. Legally binding selections from a user that is a party to the legal action may be received through the data platform. The data platform may distribute one or more goods or services associated with the legal action.

Another embodiment provides a system for monetizing user data. The system includes electronic devices executing a data application. The data application is configured to capture the user data associated with a user. The system also includes a data platform accessible by the electronic devices executing the data application through one or more networks. The data platform receives one or more data elements associated with the user data of the user from one of a plurality of sources, creates one or more tokens based on the user data, store the user data in a secure location, vends the user data to one of a plurality of parties utilizing the one or more tokens, and compensates one or more parties for vending the user data, wherein the data is accessible from the secure location utilizing an indicator included in the one or more tokens.

Another embodiment provides a system for utilizing user data. The system includes electronic devices executing a data application. The data application is configured to capture the user data associated with a user. The system also includes a data platform accessible by the electronic devices executing the data application through one or more networks. The data platform receives one or more data elements associated with the user data from the electronic devices, automatically confirms the one or more data elements are applicable to the user, adds the one or more data elements to a data set associated with the user, determines whether the data set is complete after adding the data element to the data set, and creates one or more tokens based on the data set of the user.

Another embodiment provides a data platform. The data platform may include a processor for executing a set of instructions and a memory for storing the set of instructions. The set of instructions may be executed to receive one or more data elements associated with the user data from one of a number of sources, automatically confirm the one or more data elements is applicable to the user, add the one or more data elements to a data set associated with the user, determine whether the data set is complete after adding the data element to the data set, and create one or more tokens based on the data set of the user. The tokens may be created utilizing the data type, value of purchase data and other applicable data and information.

In other embodiments, one or more of the following may be implemented. Instructions are received from the user specifying how the data set is utilized and the user is compensated for sharing the tokens with one or more interested parties. Additional data elements may be requested in response to determining the data set is incomplete utilizing questions, surveys, and a user profile associated with the user. The one or more data elements are authenticated as being associated with the user. The token is a block chain crypto token and points to the data set for secure access by one or more interested parties. Distinct data sets are clustered into a data pool, the data pool is cross populated with distinct data sets, and the data pool is segmented to identify saturation, missing, incomplete, or nonrelevant data. A determination is made regarding the relevance of the data pool to one or more interested parties. Payments are received from one or more interested parties to access the data set utilizing the token. One or more users are compensated for granting access to their data sets. The interested parties represent law firms, legal groups, government entities, or businesses that desire access to the user data in the data set.

The illustrative embodiments provide a system, method, and platform for monetizing data. A selection is received from a user to monetize data associated with the user. The data associated with user is compiled. A security token is generated including the data. The data is monetized utilizing the security token in accordance with the selection.

In other embodiments, the data may include digital profiles that are monetized for data. Data validation may be performed through user opt-ins that are identified and confirmed by the user. Token based compensation for consumer data allows for the direct control and monetization of their data (e.g., web data, application data, profiles, personal measurements, readings, etc.). Compensation may be performed through digital currencies, hard currencies, charitable contributions, and tax deductions. The earnings for a user may also be donated. Users may be rewarded for additional data uploads, updates, additions, amendments, surveys/questionnaire fulfillment, and so forth. The tokens may be utilized to pay a vendor or third party for a product, service, system, or data, secure a digital asset, tracking the life of an asset, share a stake in an asset or company, participate in an initial coin offering, receive a reward, maintaining and managing a digital asset, make a charitable contribution, or receive a tax deduction.

### BRIEF DESCRIPTION OF THE DRAWINGS

Illustrated embodiments are described in detail below with reference to the attached drawing figures, which are incorporated by reference herein, and where:

FIG. 1 is a pictorial representation of a system for managing user information in accordance with an illustrative embodiment;

FIG. 2 further illustrates portions of the system of FIG. 1 in accordance with an illustrative embodiment;

FIG. 3 is a flowchart of a process for documenting purchase data in accordance with an illustrative embodiment;

FIG. 4 is a flowchart of a process for adding users to a legal action in accordance with an illustrative embodiment;

FIG. 5 is a flowchart of a process for implementing a legal action in accordance with illustrative embodiments;

FIG. 6 is a pictorial representation of a platform for managing data in accordance with an illustrative embodiment; and

FIG. 7 depicts a computing system in accordance with an illustrative embodiment.

### DETAILED DESCRIPTION OF THE DISCLOSURE

The illustrative embodiments provide a network, system, method, platform, apparatus, and devices for managing large-scale legal matters including class-action lawsuits and mass tort litigation. A platform may be referred to as any device, system, equipment, network, or device In one embodiment, the platform may utilize a block chain-based system for identifying, classifying, tracking, monitoring, valuing, and monetizing data and managing large litigation outcomes. The illustrative embodiments provide a platform that may be utilized to provide a service that performs unique consumer and corporate tracking and monitoring methodologies to document, track, and alert individuals of each new class action lawsuit, mass tort case, legal actions, accounting issues, government matters/operations, and so forth. The platform protects the privacy of the user and may only be utilized to protect the user's legal rights and options.

As referenced herein, any large legal matter or litigation may be referred to as a legal matter(s) including, but not limited to, class action litigation, mass tort litigation, product or service liability issues, negligence, malpractice, product recalls, medical device recalls, pharmaceutical issues, mass communications to specified groups, and other similar matters, issues, and litigation. The platform may track instances of any potential, initiated, or ongoing legal matters.

The illustrative embodiments utilize blockchain-based data capture, vaulting, and vending to associate applicable user data and information (e.g., user profile, consumer data profile, etc.). User data associated with purchases of goods or services may be tokenized as part of a blockchain storage/ledger. In addition, self-identified data may also be stored as part of a user data profile. Data tokenization may be used as a means to monitor and track all of their consumer, business, and service-based purchases. The tokenized data may be cross-referenced for legal action initiation, inclusion, management, announcements, monitoring, funding, communications/newsletters, settlements, archives, and so forth.

The user's purchase data and data profile are recorded on an immutable record on the block chain. Historical, current, and future data associated with purchases of the user are tracked and stored to complete the data profile as described herein. Numerous data profiles may be searched when determining whether individual users should be a party to a legal action, receive notices, the presented options, or so forth. The user may select how their data profile is utilized. For example, the user's data profile may be only searchable when evaluating potential legal actions. In another example, the user's data profile may be utilized to present targeted marketing and advertising as preapproved by the user.

Traditionally, alerting potential plaintiffs to a legal action was time consuming, inefficient, and inexpensive. Money that is ineffectively spent trying to reach potential plaintiffs may reduce the compensation or settlements that the plaintiffs may be able receive. The illustrative embodiments provide enhanced communications as compared to traditional product warranty information, consumer product registration, mailers, television/cable advertisements, Internet and application-based advertisements (e.g., Google AdWords, Facebook, etc.), newspaper advertisements, retail/billboard advertisements, and so forth. Many times potential plaintiffs are not added to a legal action because of the described inefficiencies in reaching them. The illustrative embodiments provide a system, method, platform, and devices for finding potential plaintiffs/interested parties, performing effective communications, and ensuring judgements, assistance, replacements, renumeration, and/or compensation (depending on the type of legal action).

The illustrative embodiments provide enhancement over existing solutions and art by providing users with a greater level of consumer protection by creating the ability to tokenize their purchase data and providing self-identified data that is received, processed, and securely stored on a blockchain. The illustrative embodiments provide users an additional layer of protection and notification for legal actions that the users may legally participate in or be included. Purchases, transactions, user data, and other information are cross-referenced for accurate reporting. Updates to the user data and associated profile may be made and synchronized at any time. As a result, the most up-to-date information is utilized.

The improvements allow legal actions to be carried on more effectively providing resources, compensation, safety information, and recourse to numerous users. As a result, users may be protected from dangerous or unwanted situations and may also be compensated when determined appropriate and just. Data from multiple primary and secondary sources may be leveraged to find plaintiffs or relevant parties. Notices, communications, and legal options are delivered to users/consumers so that they can act in their own best interests.

The illustrative embodiments utilize data records from retail purchases, electronic transactions, equities, credit card transactions, user preferences, and other self-interests to record the purchase of goods and services that may be relevant to past, present, or future legal actions. Different data clearing houses, groups, or parties may be utilized to process and verify user and consumer data. For example, for shareholder actions, every stock transaction including the stock, shares, amount, type of transaction (e.g., limit, market, short, futures transaction, option, etc.), and other information is received, processed, and stored.

The illustrative embodiments provide a system, method, platform, and network for tracking, recording, encrypting, and securing user data. The data may be accessible from any number of authorized and connected devices. The illustrative embodiments allow users/consumers, consumer groups, companies, organizations, entities, governments, and other parties worldwide to develop legal strategies, communications plans, recall efforts, and/or customer/client/user outreach efforts.

As referenced herein, data refers to the personal or commercial data, transaction histories, user profiles, web profiles, purchase profiles, purchase data, application profiles, and other information applicable to a user, consumer, entity, device, system, or other party. The illustrative embodiments comply with all applicable data privacy and administration rules, laws, and best practices. Any number of mobile devices, computers, machines, servers, arrays, or so forth may be utilized to implement the illustrative embodiments. A user's data may be tokenized into a searchable asset.

The illustrative embodiments also provide the user (including selling, manufacturing, distributing, or other parties) the ability to control data generation and the seamless utilization of the data for legal actions. In one embodiment, the platform may manage numerous user data profiles that may be accessed to perform authorized legal actions and communications.

The illustrative embodiments may receive, process, collect, and source data from any number of traditional data collection methods, such as online (e.g., websites, mobile applications, user profiles, etc.) and real-world sources (e.g., location, retail purchases, credit card purchases, etc.). The illustrative embodiments are a considerable improvement over traditional class action, mass tort, and large litigation matters that require extensive targeting, advertising, communication, and marketing techniques, processes, and systems. For example, traditional blind plaintiff outreach efforts may be transformed into a precisely targeted advertisement based on user verified and confirmed data, sources and information allowing each individual user to indicate products and service purchases. Data in each user's data profile may be effectively utilized. Data points, data profiles, data sets, data pools, and other compilations of data and information may be tokenized to better track, monitor, manage, and protect the user's interests. In the example of a class action lawsuit, the plaintiffs may represent a large group or class of individuals or groups that are represented as a class and the parties may not be required to attend the proceedings or have significant interactions. The system, method, and data platform herein described may be utilized to decide whether or not to certify a class and select one or more class representatives as managed by government parties (e.g., judges, government oversight groups—FDA, FTC, etc.), private parties, or others. Judges may utilize the illustrative embodiments to manage discovery, depositions, motion practice, rulings, awards/judgements, and other portions of the case.

In one embodiment, tokens may be created that track the data. The tokens may include information or metadata regarding the data and may point to a location where the data is stored. The token may be utilized to provide a key, identifier, pointer, indicator, or link required to securely access the data. The indicator included in the token may also include a data license code. As a result, the tokens may be created, communicated, searched, and otherwise monetized through a block chain system. The tokens may include a pointer that securely points to the data being securely tracked whether for a single user, organization, company, or multiple users. In another embodiment, the tokens may include the data that is being monetized or otherwise exchanged.

The illustrative embodiments may be utilized to perform a transaction for the data. The data may be grouped, associated, and commoditized for any number of trades, exchanges, purchases, documentation efforts, or other transactions. The illustrative embodiments curate or collect data in real-time from users based on an opt-in system with clear communication, approval, compensation, and renumeration guidelines. For example, any number of computing or communications devices, platforms, applications, or so forth may be utilized to capture the data. The security tokens utilized may represent any number of existing, custom/proprietary, and other tokens. In one embodiment, formatted, structured, or unstructured data may be converted into an encrypted token that represents, includes, or references the applicable data. Data across numerous fields and with different utilizations may be captured in a token (or tokenized). The tokens may be created utilizing the data type, value of purchase data and other applicable data and information.

The security tokens may be issued, regulated, managed, and distributed by a platform to comply with the existing regulatory framework. Consumers may receive security tokens in several ways when they sign up to participate in the system/service, when and where they opt in to include their data in the marketplace, and when corporations and/or third parties search or access to their data. For example, the data may be managed within a self-directed and mobile computing environment. The illustrative embodiments allow users to determine how and when their data is shared and searched eliminating guesswork used by law firms, legal groups, companies, and others to search, user data.

In one embodiment, the tokenized data is created by the opt-in submission of a user's transaction profile, purchase data, trading profile/account, social network profile(s), website utilization profiles, or generic/customized profile, and the associated data. By opting into the program, the user is providing their profile and improving the profile to match their actual daily living and purchases of products and services. As a result, the illustrative embodiments put the user in full control of available legal actions and recourse that may be presented. The user benefits as do the third parties that are using the more accurate data to remedy, correct, compensate, or litigate an issue.

Smart contracts may be utilized with blockchain to ensure proper legal utilization of the data for authorized legal actions. The smart contract may also be referred to as a legal contract. The secured token generation process of the user data/profile provides proof of ownership to the user and ensures contract conditions are written into the smart contract code within the blockchain structure. The blockchain records maintain and track the creation, issuance, management, and monetization of each token throughout the lifetime of the user's involvement and ownership of their data. In one embodiment, a user may be rewarded with additional tokens, compensation, recognition, or rewards for keeping their data/profile updated as well as for additional participation in surveys, watching a video, verifying a purchase, study participation, receiving product marketing, expanded data provisioning, and completing questionnaires.

The users may be incentivized to provide additional data relevant to themselves or the purchased goods/services, such as pictures, audio content, videos, location (e.g., real-time, GPS, beacon, triangulation, delayed for safety, historical, etc.), Internet protocol address, identification of friends from each social network, sharing access to third-party applications, search data, testimony/testimonials, reviews, evaluations, views, likes, shares, comments, and so forth. The user data that is recorded and stored may reside permanently on the blockchain. In other embodiments, the user may pay a fee or subscribe to a service to be notified of all potential litigations. A user may also periodically login to the data platform to determine if any legal actions applicable to them are being litigated. The data platform may host a webpage or site that shows all potential notifications and allows the legal actions to be searched by the user himself/herself utilizing their data profile. As a result, the user may be able to make the determination whether participation in the legal action is warranted.

The data profile may be singular to a user or may be expanded to include deeper insights into a family, group of friends, employees, or other affiliated or associated groups. For example, a family circle profile may include an opt in for parents, children, grandparents, uncles, cousins, neighbors, family friends, and so forth. The data profile may be shared as a family asset and protection between a partner, spouse, and children allowing the family data to be managed as a single unit. Legal counsel and other relevant parties may be able to identify consumer data that is relevant to their legal action in order to provide direct notifications, requests, options, and communications.

The illustrative embodiments may also allow users to transfer or donate the compensation, damages, revenue or value generated based on the legal action for a charitable deduction or associated tax deduction. The illustrative embodiments may also be utilized to create a data index that catalogs user profiles, data sets, and data transactions. The data may be purchased, leased, or accessed based on fair compensation or court ordered amount. The various types of data and information may be utilized based on a user profile which may set data access parameters, settings, conditions, requirements, thresholds, factors, or so forth.

Acquiring parties may select a pricing structure for each type of data profile component thereby creating a virtual market for the parties to purchase real time user data. The changing values of the data may be tracked over time for specific user profiles, consumer groups, and data pools based on their value. The use of security tokens tied to user profiles creates a marketable asset that gives greater validity to commercial uses of blockchain technologies and the security token market.

Cryptographic, security, or digital tokens may be exchanged for actual currency, replacement goods/services, gift cards, vouchers, and other forms of compensation. Tokens may be utilized to communicate data and compensate users, service providers, aggregators, advertisers/marketers, and other applicable parties. The systems may also manage any number of smart contracts between relevant parties, such as the users/consumers, legal service providers, compensating companies/groups, governments, network operators, content providers, and so forth. The tokens utilized by the illustrative embodiments may be utilized for any number of purposes including compensation, communicating keys to the data, data sets, and data pools, and secure management of the data. The system may utilize multiple types of tokens (e.g., asset tokens, utility tokens, etc.) that are utilized together within the blockchain. Various smart contracts and/or decentralized applications may be self-executed to process and manage the various transactions occurring on the blockchain. The illustrative embodiments including the systems, methods, devices, processes, and components described herein may implement any number of blockchain implementations.

The block chain system may utilize crypto-protocols and crypto-token-protocols. For example, the block chain system may generate tokens, manage a protocol utilizing a consensus algorithm, and record the transactions and other actions in a distributed ledger. The various protocols may control who, when, and how the various parties may control and otherwise manage the blockchain through any number of public and private permissions.

In one embodiment the platform may be utilized to track any product that contains or may contain chemicals and compounds that have been identified as a potential cause for health-related diseases, such as products containing asbestos or opioids. For example, asbestos may result in mesothelioma and lung cancer which are dose-related diseases which may often take years until the first signs of illness are exhibited in patients. These diseases often have a 20-year or more latency period and often causes secondary exposure to hazardous materials to a spouse, family member, partner, roommate, or pet through second-hand contact. Through corporate point of sale data-streams the platform may track the consumer retail and corporate sales of each product line that contains a known harmful compound and may alert users who have purchased a product once the product becomes the subject of a class action lawsuit or mass tort case. In the example of opioids, user addictions, well-being, or status may be accurately tracked for the same reasons.

In one embodiment the platform is utilized to allow workers or employees to self-document their contact with any suspected or known harmful compound they come in contact with, in a workplace scenario. Consumers can also self-document their contact with any suspected or known harmful compound they come in contact within a non-workplace setting. The platform can also document and vault consumer health data to indicate that a user was part of a procedure that is now the subject of a class action matter and can also document if a user lead a healthy lifestyle through purchase records and can further indicate through documentation of medical procedures a user was proactive once they learned about their exposure or illness.

In another embodiment the platform is utilized to incentivize retailers to keep a detailed record of any sale of products, especially a product that is hazardous, dangerous, or contains a potentially harmful compound as a means to exclude their corporation from any third-party inclusion in a class action or mass tort lawsuits. Retailers may determine the value of maintaining and managing a data stream that tracks all sales of products to indicate when a potentially dangerous compound or product is or might be associated with any type of product recall or class action notification. Retailers, manufacturers, and distributers may also use information from the data platform to make more informed purchase decisions through platform-based indications related to the potential for unsafe products or compounds used in a product.

In another embodiment the platform is utilized to document and track a patient who has completed any medical procedure. The user/patient self-identifies as a patient who has had a specific operation or procedure. The platform may document each medical device, medical device component, surgeon, equipment, known procedure complications, medications, and any other relevant device, drug, or component part utilization that is currently in use or could be used for each specific medical procedure and monitor specific class action and mass tort-based data feeds to alert any user to a potential, pending, or in-process product recall, class action review, lawsuit, or mass tort case.

In another embodiment the data platform may be utilized to document pharmaceuticals, prescriptions, drug compounds and over the counter (OTC) drugs that a consumer takes or has taken. In this example, the data platform my record transaction data, interface with a patient portfolio, and/or the user self identifies for each instance they fill a prescription or make purchase in which they use a prescribed medication, medical device, or OTC drug. The platform documents both the self-identification and the point-of-sale purchase of each medication taken and can indicate in the future if a medication a consumer has used or currently uses is now the subject of a class action lawsuit, medical monitoring, or mass tort case.

In one embodiment the platform is utilized to monitor drug formularies for health insurance companies, employers, unions who provide health insurance to union members, or other entities that use formularies for their insureds. These formularies may include prescription drugs approved by the entity covering the insureds that include both the brand name and generic versions of a drug. The drugs and their component parts are monitored to indicate if a formulation of a drug or a specific component part has been identified as containing or potentially containing a dangerous component and may alert users accordingly.

In another embodiment the data platform is utilized as a system for tracking and monetizing class actions lawsuit or other legal action for the purpose of donation to a charity. The platform tracks a record each instance of a class action lawsuit settlement participation and can be configured to automatically donate any proceeds to a charity of their choice. The platform also provides proof of a charitable donation for tax purposes.

In another embodiment the data platform is utilized as a system for tokenizing the data records across a consumer or health care segment or across an entire consumer population which is utilized for tracking, indicating and monetizing lead referrals of plaintiffs to legal specialists at class action and mass tort law firms, government entities, or legal groups. For example, monitoring subscriptions may be provided to the user and the platform may set exclusives data offers and subscription premiums with a law firm that are willing to pay for access to leads in a specific category of litigation.

In one embodiment the platform is utilized as a system for tokenizing data records related to patent claims coverage and may indicate products or services with potential patent infringement based on known patent claims coverage. The data platform may be utilized for tracking and monitoring patent claim coverage in the same fashion as tracking potential class action and mass tort lawsuits.

In another embodiment the platform is utilized as a system for tokenizing data and purchase records related an automotive vehicle purchase. Each element of an automotive purchase is documented via the blockchain and used as a secondary means of documentation that covers the total bumper to bumper vehicle purchase warranty and may also document each component part used in the manufacturing of that vehicle including frame, engine, tires, airbags, sensors, and so forth. This documentation provides an added layer of consumer proof of warranty and recall protection when alerting consumers to a recall that may affect an automobile they own or drive.

In another embodiment, a trading exchange, platform, brokerage, depository trust, trade clearing corporation, trading custody, transfer agent or other securities-based or holdings-based data provider provides data for the platform that is then tokenized and represented within virtual reality and made available in digital form. The data represented in a tokenized form may then then accessed by lawyers, brokers or intermediaries who utilize the platform to purchase, lease, or rent the data for the purpose of identifying who owned a stock, security or company during a given time period and how much of the security was owned. The token when purchased provides access to the data and the class or security tort action members who may be contacted for participation in the class.

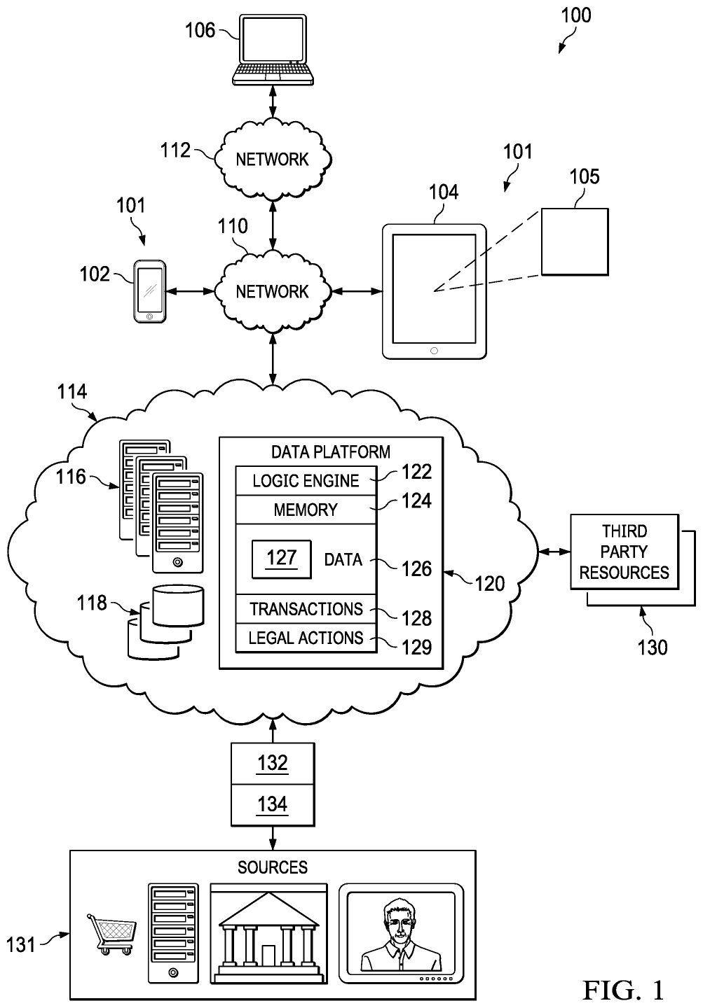

FIG. 1 is a pictorial representation of a system 100 for managing user information in accordance with an illustrative embodiment. In one embodiment, the system 100 of FIG. 1 may include any number of devices 101, networks, components, software, hardware, and so forth. In one example, the system 100 may include a smart phone 102, a tablet 104 displaying graphical user interface 105, a laptop 106 (altogether devices 101), a network 110, a network 112, a cloud system 114, servers 116, databases 118, a data platform 120 including at least a logic engine 122, a memory 124, data 126, tokens 127, and transactions 128. The cloud system 114 may further communicate with sources 131 and third-party resources 130. The various devices, systems, platforms, and/or components may work alone or in combination.

Each of the devices, systems, and equipment of the system 100 may include any number of computing and telecommunications components, devices or elements which may include processors, memories, caches, busses, motherboards, chips, traces, wires, pins, circuits, ports, interfaces, cards, converters, adapters, connections, transceivers, displays, antennas, operating systems, kernels, modules, scripts, firmware, sets of instructions, and other similar components and software that are not described herein for purposes of simplicity. For example, the software/applications or hardware may implement all or portions of the processes, methods, and embodiments described herein and shown in the Figures.

In one embodiment, the system 100 may be utilized by any number of users, organizations, or providers to aggregate, manage, review, analyze, process, distribute, advertise, market, display, and/or monetize data 126. The data may include personal data, commercial data, data points, data sets, data pools, and other forms of data. For example, the data 126 may be associated with purchases, acquisition or utilization of goods or services associated with the user (as well as family, friends, employees, associates, or acquaintances as allowed or specified). In one embodiment, the goods and services represent any number of items, content, products, or services sold, manufactured, distributed, managed, or monitored by a business, entity, organization, or entity. In one embodiment, the system 100 may utilize any number of secure identifiers (e.g., passwords, pin numbers, certificates, etc.), secure channels, connections, or links, virtual private networks, biometrics, or so forth to upload, manage, and secure the data 126, generate tokens, and perform applicable transactions. Various authentications and verifications may be performed to ensure that data is true and accurate.

As noted, the system 100 may be a blockchain system that utilizes a digital ledger to track tokens 127, transactions 128 involving the data 126 and legal actions 129. For example, the digital ledger may store the data 126, tokens 127, transactions 128, and legal actions 129 along with their details, information, and data. For example, blocks of data 126, tokens 127, transactions 128, and legal actions 129 may be chained together in the blockchain through distributed documentation. The devices 101 are representative of multiple devices that may be utilized by businesses or consumers, including, but not limited to the devices 101 shown in FIG. 1. The devices 101 utilize any number of applications, browsers, gateways, bridges, or interfaces to communicate with the cloud system 114, platform 120, and/or associated components. The devices 101 may include any number of Internet of Things (IoT) devices, home, and commercial devices.

The data 126 may include a number of different data types. The data 126 may include demographic data, consumer data, family and health data, property data, interests and activity data, and other applicable types of data. The data 126 or legal actions 129 may store the goods, services, and products that the user has purchased, used, or is interested in. As noted, the user may represent individuals, families, groups, entities, businesses, aggregations, or other parties.

Demographic data may be a combination of static and influx data points that include age, gender, occupation, marital status, education/education level, income level, religion, birthday, family size, and so forth. Demographic data, although mostly static, is commonly quite important to companies, government groups, legal groups, marketers, and other interested parties. Consumer data may include websites visited, purchase plans, purchases, brand affinity, cars, clothes, travel, and other information applicable to users, clients, customers, groups, or so forth. The family and health data may include permanent or long-lasting data elements which may be helpful for determining damages based on events or purchased goods and services and predicting future purchases and include information related to family, health, and medical conditions, such as childcare, diapers, diabetes, incontinence, rental information, and so forth. The family and health data have a large potential for cross referencing of data. Property data may include information regarding ownership, rentals/renters, address, for sale, occupants, pool, and vehicle ownership. This data may be treated and value as static data (even though changes are likely and expected). The interests and activity data may include data regarding hobbies, general interests, product and brand preferences, and other applicable influx data. Political affiliation data may be a matter of public record in many states or the user may self-identify. The data may be static, or perennial based on the user's voting record. The user may choose to self-identify political and voting information or may keep that information private.

The wireless device 102, tablet 104, and laptop 106 are examples of common devices 101 that may be utilized to capture, receive, and manage data 126, perform transactions 128, and communicate legal actions 129. For example, the various devices may capture data relevant to the user that is subsequently utilized or monetized for the benefit of the user (e.g., location, purchases, behavior, web activity, application use, digital purchases, events, actions, etc.). Other examples of devices 101 may include e-readers, cameras, video cameras, electronic tags, audio systems, gaming devices, vehicle systems, kiosks, point of sale systems, televisions, smart displays, monitors, entertainment devices, medical devices, virtual reality/augmented reality systems, or so forth. The devices 101 may communicate wirelessly or through any number of fixed/hardwired connections, networks, signals, protocols, formats, or so forth. In one embodiment, the smart phone 102 is a cell phone that communicates with the network 110 through a 5G connection. The laptop 106 may communicate with the network 112 through an Ethernet, Wi-Fi connection, cellular, or other wired or wireless connection.

The data 126 may be collected and sourced from any number of online and real-world sources including, but not limited to, clearinghouses (e.g., stocks, credit card transactions, payment processors, etc.), website traffic and cookie-based analytics, social media and application data, point of sale, purchase, and transaction history, loyalty programs and coupons, payment services, location-based email list for mailers, surveys and questionnaires, and other applicable sources. The data 126 may be captured based on the permissions, authorization, and confirmation of the user. For example, the data 126 may include purchase records for retailers, resellers, e-commerce sites, and other applicable groups. The data 126 may also store information regarding a user's purchases (e.g., past, present, future, likely, etc.), interests (e.g., personal, commercial, etc.), business/business needs, and other applicable information. The data 126 may also store information regarding the family, friends, and associates of the user if authorized or requested by the user.

These same data collection sources may be utilized to perform analysis of the data 126. In one embodiment, the data 126 may be captured through registered account information, programs/applications, website traffic, and tracking cookie-based analytics. For example, information, such as time spent on each site, page views, clicks, conversions, relevant content, trends, and other information may be recorded as part of the data 126. The data 126 may also include digital or online transactions performed through services, such as PayPal, Venmo, Zelle, Google, Square, WePay, Skrill, Payza, Stripe, Dwolla, Amazon Pay, 2checkout, and other existing or developing services.

The data 126 may also be captured through social media and applications. Social media data may be utilized to provide real-time polls, surveys, questionnaires, likes and dislikes, feedback, preferences for media content, site traffic, interests, and numerous other consumer data. Any number of mobile, computing, personal assistant (e.g., Siri, Alexa, Cortana, Google, etc.), or other applications may be utilized. Social media data may be utilized as definitive or anecdotal data.

The data 126 may also be captured through point of sale (POS) transactions, card transactions, in-person purchase, digital purchases, and purchase histories. In one embodiment, a credit card clearing house may be utilized to capture the data. Customers, consumers, and clients may be comfortable with sharing the specific data points associated with point-of-sale transactions due to established practices. The point-of-sale transactions may include extensive data, including, but not limited to, name, address, item/service, price, credit card type, purchase location, date, brand preference, brand category, product affinity, spending levels, order history, inventory, restock data, purchase demographics, and so forth. Point-of-sale and transaction history data may have static, perennial, and influx data points with the value of each data point being tracked and measured for relevant legal actions.

The data 126 may also include location-based information and communications. An example of static and perennial data points that may be collected include a standard web form, email request form, wireless triangulation, routers/towers/access points reached, proximity beacons, and so forth. The location-based communications may capture data, such as email, consumer/business addresses, phone numbers, and so forth. For example, users in a specific location, region, or environment may have been harmed or potentially harmed requiring immediate communications, interventions, warnings, or so forth.

The data 126 may also include surveys and questionnaires. Responses to surveys and questionnaires may be one of the best ways to gather and inform information regarding the user's purchase or use of goods and services, demographics, interests, and preferences that may not be able to be determined in other ways due to privacy, entity names, applicable laws, and so forth. The ability to gather real-world user insights, experiences, facts, and perceptions may help complete or round out a user profile. The surveys and questionnaires may be performed digitally (e.g., websites, extensions, programs, applications, browsers, texting, or manually (e.g., audibly, on paper, etc.). Responses to surveys and questionnaires may help achieve saturation of datapoints for user profiles.

The cloud system 114 may aggregate, manage, analyze, and process data 126 and tokens across the Internet and any number of networks, sources 131, and third-party resources 130. For example, the networks 110, 112, 114 may represent any number of public, private, virtual, specialty (e.g., trading, financial, cryptocurrency, etc.), or other network types or configurations. The different components of the system 100, including the devices 101 may be configured to communicate using wireless communications, such as Bluetooth, Wi-Fi, cellular communications, or so forth. Alternatively, the devices 101 may communicate utilizing satellite connections, Wi-Fi, 3G, 4G, 5G, LTE, personal communications systems, DMA wireless networks, and/or hardwired connections, such as fiber optics, T1, cable, DSL, high speed trunks, powerline communications, and telephone lines. Any number of communications architectures including client-server, network rings, peer-to-peer, n-tier, application server, mesh networks, fog networks, or other distributed or network system architectures may be utilized. The networks, 110, 112, 114 of the system 100 may represent a single communication service provider or multiple communications services providers.

The sources 131 may represent any number of clearing houses, web servers, service providers (e.g., trading platforms, credit card companies, transaction processors, etc.), distribution services (e.g., text, email, video, etc.), media servers, platforms, distribution devices, litigation software/services, or so forth. In one embodiment, the sources 131 may represent the law firms, businesses, organizations, individuals, or groups that purchase, license, search, acquire, or utilize the data 126, such as researching previous transactions utilizing the system 100. In one embodiment, the cloud system 114 (or alternatively the cloud network) including the data platform 120 is specially configured to perform the illustrative embodiments and may be referred to as a system or platform. In another embodiment, the sources 131 may represent litigation, case management, and communications software, services, systems, platforms, equipment, components, and/or services. The sources 131 may alternatively be integrated with the data platform 120 or cloud system 114. For example, the data platform 120 may integrated the various embodiments with litigation management software and services to further enhance participation, communications, and results.

The cloud system 114 or network represents a cloud computing environment and network utilized to aggregate, process, manage, search, verify, generate, sell, monetize, and distribute data 126 and legal actions 129 while supporting the transactions 128 and utilization. The cloud system 114 may implement a blockchain system for managing the data 126, transactions 128, and legal actions 129. For example, any number of blockchain tokens may be utilized to manage the data and ensure proper compensation of the user. The cloud system 114 allows data 126, transactions 128, and legal actions 129 from multiple businesses, users, managers, or service providers to be centralized. In addition, the cloud system 114 may remotely manage configuration, software, and computation resources for the devices of the system 100, such as devices 101.

The cloud system 114 may prevent unauthorized access to data 126, tools, and resources stored in the servers 116, databases 118, and any number of associated secured connections, virtual resources, modules, applications, components, devices, or so forth. In addition, a user may more quickly upload, aggregate, process, manage, view, and distribute data 126 (e.g., profiles, updates, surveys, content, etc.), transactions 128, and legal actions 129 where authorized, utilizing the cloud resources of the cloud system 114 and data platform 120.

The cloud system 114 allows the overall system 100 to be scalable for quickly adding and removing users, businesses, authorized sellers, interest-based information, transaction-based information, analysis modules, distributors, valuation logic, algorithms, moderators, programs, scripts, filters, transaction processes, distribution partners, or other users, devices, processes, or resources. Communications with the cloud system 114 may utilize encryption, secured tokens, secure tunnels, handshakes, secure identifiers (e.g., passwords, pins, keys, scripts, biometrics, etc.), firewalls, digital ledgers, specialized software modules, or other data security systems and methodologies as are known in the art.

Although not shown, the cloud system 114 may include any number of load balancers. The load balancer is one or more devices configured to distribute the workload of processing the uploaded data 126 as well as applicable transactions to optimize resource utilization, throughput, and minimize response time and overload. For example, the load balancer may represent a multilayer switch, database load balancer, or a domain name system server. The load balancer may facilitate communications and functionality (e.g., database queries, read requests, write requests, command communications, stream processing, etc.) between the devices 101 and the cloud system 114. For example, the cloud system 114 may offload verification of users that seek to be added to the system 100 along with applicable data 126 and information. Load balancing may be performed between automatic systems and devices as well as individual users. Other intelligent network devices may also be utilized within the cloud system 114.

The servers 116 and databases 118 may represent a portion of the data platform 120. In one embodiment, the servers 116 may include a web server 117 utilized to provide a website, mobile applications, and user interface (e.g., user interface 107) for interfacing with numerous users. Information received by the web server 117 may be managed by the data platform 120 managing the servers 116 and associated databases 118. For example, the web server 117 may communicate with the database 118 to respond to read and write requests. For example, the servers 116 may include one or more servers dedicated to implementing and recording blockchain transactions and communications involving the data 126, transactions 128, and legal actions 129. For example, the databases 118 may store a digital ledger for updating information relating to the user's data 126 and transactions 128 as well as utilization of the data 126 and transactions 128 to generate and communicate the legal actions 129. The databases 118 may be an integrated portion of the blockchain as is known in the art. For example, the user's data 126 may be linked to in digital tokens that may be securely communicated to any number of relevant parties.

The databases 118 may utilize any number of database architectures and database management systems (DBMS) as are known in the art. The databases 118 may store the available content associated with each user/consumer/purchaser which may specify a date of purchase, product/service information, address, name, age, demographics, interests, family/friend information, biometric identifiers, payment information, permissions, settings, location, cause preferences, cause restrictions, and so forth. Any number of secure identifiers, such as passwords, pins, tones, codes, serial numbers, or so forth may be utilized to ensure that content, personal, or transaction information is not improperly shared or accessed. The databases 118 may include all or portions of a digital ledger applicable to one or more block chain transactions including token generation, management, exchange, and monetization.

The user interface 105 may be made available through the various devices 101 of the system 100. In one embodiment, the user interface 105 represents one or more of a graphical user interface, audio interface, tactile interface, or other interface that may be utilized to manage data, transactions, and other information. For example, the user may enter, or update associated data utilizing the user interface 105 (e.g., browser or application on a mobile device). The user interface 105 may be presented based on execution of one or more applications, browsers, kernels, modules, scripts, operating systems, or specialized software that is executed by one of the respective devices 101.

The user interface 105 may display current and historical data as well as trends and projections. The user interface 105 may be utilized to set the user preferences, parameters, and configurations of the devices 101 as well as upload and manage the data, content, and implementation preferences sent to the cloud system 114. The user interface 105 may also be utilized to communicate the legal actions 129 to the user. The devices 101 (e.g., displays, indicators/LEDs, speakers, vibration/tactile components, etc.) may present, play, display, or otherwise communicate the legal actions 129 visually, audibly, tactilely, or any combination thereof.

The user interface 105 may also be utilized to present questionnaires, surveys, forms, and other applicable information. The user interface 105 may be utilized to perform litigation tracking and management with respect to legal actions 129 that may be carried out based on the data 126 and transactions 128. The user interface 105 may be utilized to add plaintiffs or other parties/units (e.g., expert witnesses, lawyers, legal staff, witnesses, deposition software, litigation management platforms, etc.) to a litigation. Tasks may be performed to manage the legal actions 129. For example, plaintiffs and others may be added to the legal actions 129 based on information in the data 126 or transactions 128. The data platform 120 may communicate with or integrate with docketing and litigation management software and systems to manage all aspects of the legal actions 129. For example, software specific to litigation management (e.g., class action suits, large scale tort actions, government actions, etc.) may be executed by the devices 101.

In one embodiment, the system 100 or the cloud system 114 may also include the data platform 120 which is one or more devices utilized to enable, initiate, generate, aggregate, analyze, process, query, and manage data 126, transactions 128, legal actions 129, and so forth with one or more communications or computing devices. The data platform 120 may include one or more devices networked to manage the cloud network and system 114. For example, the data platform 120 may include any number of servers, routers, switches, or advanced intelligent network devices. The data platform 120 may represent one or more web servers that perform the processes and methods herein described. The cloud system 114 may manage block chain management of the data 126 utilizing block chain technologies, such as tokens, digital ledgers, hash keys, instructions, and so forth.

In one embodiment, the logic engine 122 is the logic that controls various algorithms, programs, hardware, and software that interact to receive, aggregate, analyze, rank, process, manage, score, communicate, and distribute the legal actions 129, transactions 128, data 126, content, transactions, alerts, reports, messages, or so forth. The logic engine 122 may utilize any number of thresholds, parameters, criteria, algorithms, instructions, or feedback to interact with users and interested parties and to perform other automated processes. In one embodiment, the logic engine 122 may represent a processor. The processor is circuitry or logic enabled to control execution of a program, application, operating system, macro, kernel, or other set of instructions. The processor may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks. The processor may be a single chip or integrated with other computing or communications elements.

The memory 124 is a hardware element, device, or recording media configured to store data for subsequent retrieval or access at a later time. The memory 124 may be static or dynamic memory. The memory 124 may include a hard disk, random access memory, cache, removable media drive, mass storage, or configuration suitable as storage for data 126, transactions 128, instructions, and information. In one embodiment, the memory 124 and logic engine 122 may be integrated. The memory 124 may use any type of volatile or non-volatile storage techniques and mediums. In one embodiment, the memory 124 may store a digital ledger and tokens for implementing a blockchain processes.

In one embodiment, the cloud system 114 or the data platform 120 may coordinate the methods and processes described herein as well as software synchronization, communication, and processes. The third-party resources 130 may represent any number of human or electronic resources utilized by the cloud system 114 including, but not limited to, businesses, entities, organizations, individuals, government databases, private databases, web servers, research services, and so forth. For example, the third-party resources 130 may represent law firms, physical or online retailers, advertisement agencies, marketers, e-commerce companies, verification services, credit monitoring services, block chain services, payment providers/services, and others that store the data 126 and transactions 128 and/or that track or perform the legal actions 129. The third-party resources 130 may also pay for rights to use the data 126, track or provide information regarding the transactions 128, and create or monitor utilization of the legal actions 129.

In one embodiment, the data platform 120 may implement a blockchain ledger, manager, or technology. In another embodiment, the blockchain ledger may be accessible through sources 131. Any number of existing, developing, or future blockchain companies or providers may be utilized (e.g., Aeternity, Ethereum, Bitcoin, Dfinity, ContentKid, Blockphase, Chain of Things, Flowchain, Decissio, Cognate, SkyHive, Safe, etc.).

The blockchain is utilized as a way to store and communicate the data 126, transactions 128, and legal actions 129. The blockchain may utilized one or more distinct ledgers for different entities, services providers, types of data, users, or so forth. For example, each new user with data received by the data platform 120 is assigned a token or other secure identifier. In one embodiment, the digital tokens may be managed utilizing a key that allows the user or controlling party to access the ledger. In one example, the tokens may be controlled by the user or control may be reassigned. The blockchain may cross-reference updates to the data 126 with the original record for the data platform 120 to ensure proper updates, documentation, maintenance, control, licensing, management, and transactions. In one example, different licensing tiers, pricing algorithms, license verification, cause information, and payments are combined to create a unique platform. The illustrative embodiments provide a system 100, cloud system 114, and data platform 120 for using user data, specifically stocks, equities, ownership, holdings, and interests, to generate selective or targeted advertising. The illustrative embodiments are performed based on the user's request, authorization, or approval to apply with all applicable laws.

The blockchain may also utilize any number of payment systems (e.g., PayPal, Venmo, Dwolla, Square, wire transfers, credit cards, Quicken, etc.) to receive money and distribute payments to the applicable party. In one embodiment, the data platform 120 may receive a small fee or percentage per search/query, transaction, data uploaded/updated, data purchased, shared, or licensed, purchased item, browsing session, or so forth. The data platform 120 may also be compensated for plaintiffs that are found or added as parties to the legal actions 129. As a result, service providers, legal groups, and individuals may be incentivized to participate in the legal process (e.g., tracking purchases, verifying purchases, becoming a party to a legal matter, providing sworn statements, testimony, or documentation, etc.) benefiting both individuals, companies, governments, and others. In one embodiment, the data platform 120 may be utilized to verify plaintiffs/users/individuals/participants (as well as other users/entities that utilize the data platform 120) and associated data 126 and transactions 128 associated with the data 126.

The third-party resources 130 may represent any number of electronic or other resources that may be accessed to perform the processes herein described. For example, the third-party resources 130 may represent government, private, and charitable servers, databases, websites, programs, services, and so forth for verifying the data 126, transactions 128, and the legal actions 129. In another example, auditors may verify the legal actions 129 are actually generated based on the data 126 including the transactions 128.

Various data and venue owners that access the data platform 120 may legally extract and tokenize the data 128, transactions 128, and legal actions 129 for use in the exchange provided by the system 100 by identifying and tracking data utilizing automatic data extraction tools. Any number of privacy and data policies may be implemented to ensure that applicable local, State, Federal, and International laws, standards, and practices are procedures are met.

In one embodiment, a user or legal group represented by a user of the devices 101 or the sources 131 may elect and receive permission to collect data 126 collected from secure and authorized systems to achieve access to partial or complete data from the sources 131 (e.g., retailers, technical companies, payment processors, credit monitors, etc.).

The logic engine 122 may also perform other methods and processes as are taught by U.S. provisional patent application 62/755,815 entitled “Method and System for Data Valuation and Secure Commercial Monetization Platform” and filed Nov. 5, 2018 and corresponding PCT/US19/59920 filed Nov. 5, 2019 and as is taught by U.S. provisional patent application 62/826,457 entitled “Method and System for Data Futures Platform” filed Mar. 29, 2019 and corresponding PCT/US20/25495 filed Mar. 27, 2020, and U.S. provisional patent application 62/946,646 filed Dec. 11, 2019 and U.S. utility patent application Ser. No. 17/119,479 entitled “Platform for Management of User Data” and filed Dec. 11, 2020 which are hereby incorporated by reference in their entirety. The illustrative embodiments may also support third-party utilization of the data 126 and transactions 128 to generate the legal actions 129. Various authorization, auditing, and validation processes may be performed by auditing groups, commissions, industry groups, or other professionals/entities. The various embodiments may also allow a user to donate the value of their data 126 and transactions 128 and consumption of legal actions 129.

In one embodiment, the logic engine 122 may utilize artificial intelligence and machine learning. The artificial intelligence and machine learning may be utilized to enhance data 126, analyze transactions 128, and generate legal actions 129 to increase value, utilization, effectiveness, and profits. For example, artificial intelligence may be utilized to review, authenticate, and validate data and transactions that are received by the system 100. The artificial intelligence and machine learning of the logic engine 122 may be utilized to ensure that the data 126 is improved, accurately analyzed, and value increased. For example, it is expected that data and the associated tokens that are validated utilizing artificial intelligence may be given a premium value by advertisers.

In another embodiment, the devices 101 may include any number of sensors, appliances, and devices that utilize real time measurements and data collection to update the data 126. For example, a sensor network, wearables (e.g., watches, bands, implantable devices, etc.) and Internet of things (TOT) devices may gather user and behavioral data. The data platform 120 may also work in conjunction with hands-free data mining and measurement tools that tracks location, activity, and video-based marketing data (e.g., from GPS location, video from storefronts, beacon detection, proximity alerts, etc.) from any number of third-party sources. The user may be tracked through any number of environments, locations, and conditions. The legal actions 129 may also be generated based on the activities, actions, and location of the user.

In one embodiment, the data platform 120 may extract data from third-party platforms by opting in and providing user credentials to various applications (e.g., Google, Amazon, eBay, Microsoft, etc.) the data platform 120 may extract data from the sources 131.

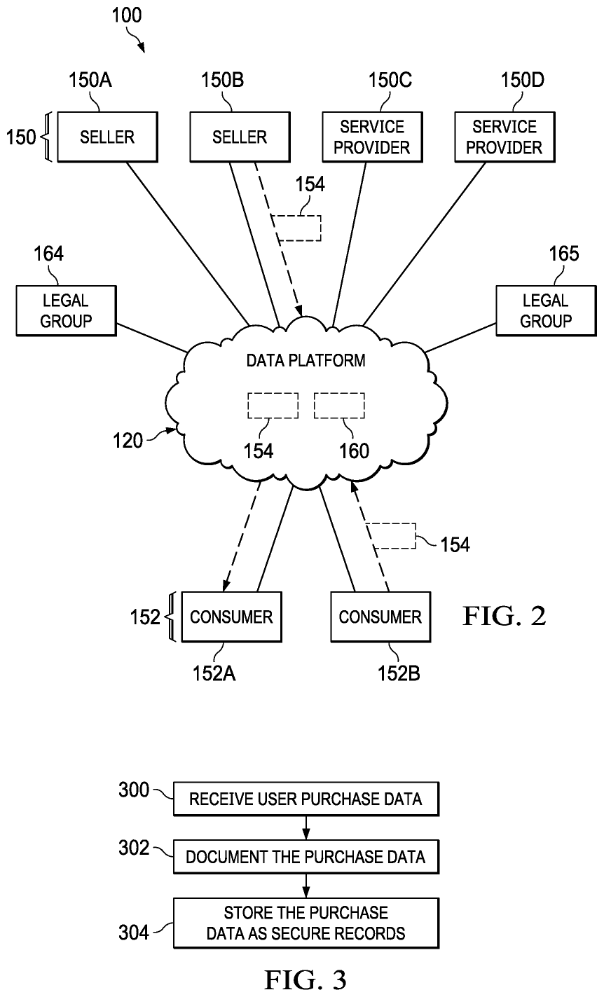

FIG. 2 further illustrates portions of the system 100 of FIG. 1 in accordance with an illustrative embodiment. As shown the sellers 150A, 150B and service providers 150C, 150D (jointly sources 150) may represent the sources 131 of FIG. 1. The sources 150 may represent any number of retailers, exchanges, platforms, clearinghouses. advertisers, marketers, businesses, retailers, service providers, individuals, organizations, entities, or so forth referred to as sellers 150A, 150B or service providers 150C, 150D for purposes of simplicity. The sources 150 may provide goods or services purchased or used by the consumers 152A, 152B. The consumers 152A, 152B (jointly consumers 152) represent any number of users, consumers, groups, or individuals that have data 154 (also including transactions) that may be searched to find potential parties to a legal action. Searches, data management, communications, and other physical or electronic processes may be performed as part of a legal action implemented utilizing the data platform 120. In one embodiment, the data platform 120 may represent all or portions of the system 100 of FIG. 1 (including the cloud system 114, servers 116, and databases 118).

The legal groups 164, 165 represent one or more law firms, legal groups, government entities, businesses, advocacy groups, or other groups that handle legal actions 160. The legal groups 164, 165 may represent any number of plaintiffs, defendants, judges, advocacy groups, or other applicable parties. As noted, the legal actions may represent one or more class action litigations, mass tort litigations, product or service liability issues, negligence, malpractice, product recalls, medical device recalls, pharmaceutical issues, mass communications to specified groups, and other similar matters, issues, and litigation The class actions or mass litigation may relate to any topic including, but no limited to, environmental, finance, employment, civil rights, product defects, pharmaceuticals, dangerous drugs, unsafe ingredients, medical malpractice, medical devices, medical implants, medical monitoring, product recalls, unsafe products, dangerous products, defective products, choking hazard, product liability, catastrophic injury, asbestos-related diseases, toxic contamination, medical monitoring, aviation, automobile recalls, bankruptcy trusts, securities class action, data breech, environmental class action, aviation, loss of cabin pressure, plane defect, dangerous pilot, plane crashes, and so forth. In addition to tracking class action lawsuits and mass tort litigation, the illustrative embodiments may be utilized for purchase tracking, product warranties, lifetime product guarantees, medication tracking, medication recalls, drug component recalls, unsafe product alerts, product recalls, generic product liability, HIPAA compliance, labor unions, voting, securities, shareholder voting, patent licensing, patent infringement, consumer profile validity,

The sources 150, consumers 152, or legal groups 164, 165 may actively or passively upload data 154 to the data platform 120. The data platform 120 may also receive amended, updated, or add additional data 154 for the consumers 152 at any time as described herein. The consumers 152 may have an agreement (e.g., contract, terms of services, client engagement, permissions, authorizations, etc.) for the utilization of the data 154 by the sellers 150 or other interested parties to participate in the legal actions 160, receive relevant communications, or otherwise participate. The agreement or contract may specify how, when, and what portions of the data 154 may be used as well as the associated compensation, access, and utilization terms. The agreement may specify that the data 154 may be processed, shared, analyzed, purchased, licensed, rented, leased, or otherwise managed by the data platform 120 for the mutual benefit of the consumers 152, sources 150, and the legal groups 164, 165. For example, the consumer 152B may elect to receive notices, alerts, or communications regarding potential or pending legal actions 160. The consumers 152 may be interested in the legal actions 160 to protect their interests, health, property, and other rights. In one example, the consumer 152B may elect to share their data 154 so that the consumer 152B may be alerted to the relevant legal actions 160.

In one embodiment, the data 154 may represent blockchain updates, such as ledger updates. The data 154 may also represent tokens that include data or that include a secure identifier that may be utilized with or without other credentials, passwords, or so forth to access secured data. The data 154 may represent any portion of a suit, action,

The data platform 120 performs aggregation of the data 154 to perform required or needed actions for the legal actions 160. In one embodiment, the legal groups 164, 165 may utilize the data to find or verify potential plaintiffs/participants in the legal actions 160. The data 154 may be accessed utilizing digital tokens that link to the data 154. The tokens may include secured links, keys, access information, unique identifiers, secure information, or authorizations for accessing the data 154 from the data platform 120. The tokens may be valued and secure to prevent unauthorized, illegal, and/or illegitimate access. The consumers 152A, 152B may be compensated for utilization of their data 154 through hard currencies or digital currencies, such as cash, credits, tokens, coupons, discounts, rebates, or other monetary incentives. When using digital tokens or currency, full tokens or partial tokens may be utilized to most accurately represent the values being exchanged. The tokens granted through the data platform 120 may vary in value, may be fixed, or may act similar to other monetary instruments (e.g., stocks, bonds, certificates of deposit, etc.) for a specified original value of the data 154.

The data platform 120, sources 150, legal groups 164, 165 or consumers 152 may keep and maintain digital ledgers that track the transactions within the system 100 to verify and authenticate the data 154, legal actions 160, and associated transactions. The sources 150 may utilize the data 154 to initiate, conduct, or manage legal actions, or search transactions, purchased goods and services, products, research, generate analytics, and otherwise coordinate communications between the parties/groups associated with the system 100. As previously noted, the data platform 120 may also represent one or more processing, analysis, blockchain, or distribution centers, systems, devices, facilities, or so forth. The sources, consumers 152, and legal groups 164, 165 may represent any number of individuals or groups (e.g., hundreds, thousands, millions, etc.).

As noted, the sellers 150A, 150B, service providers 150C, 150D, and legal groups 164, 165 may perform transactions or communicate directly or indirectly with the consumers 152. sellers 150 may send or distribute goods and services associated with the advertisements 155 through the cloud system or directly to the consumers 152. The data platform 120 may be utilized to manage communications, distributions, treatments, services, or other compensation. For example, the system 100 and data platform 120 may include any number of physical storages, digital storage, warehousing, equipment, medical, legal, and distribution services and systems, facilities, professionals, employees, contractors, electronics, and so forth.

The data platform 120 is unique in the way that data is tracked and utilized. Existing systems do not allow a user to control how and when their data is utilized. Most users are unable to control how their data is utilized by search companies, social media companies, online retailers, and others. The platform and implemented methods provide a unique and transparent manner to track data of a user and utilize the data for authorized legal actions, matters, cases, and/or purposes. The interactions between consumers 152 and the sellers 150 through the data platform 120 is unique and mutually beneficial. The illustrative embodiments provide the system for better tracking data (e.g., data packets 154) that may be subsequently utilized to update advertisements and marketing that is presented to the consumers 152 by the sellers 150 (or other parties). The system 100 and data platform 120 may be a unique portion of a block chain system that enables for user and transaction data to be securely recorded, managed, and accessed.

FIG. 3 is a flowchart of a process for documenting purchase data in accordance with an illustrative embodiment. The process of FIGS. 3-6 may be performed by a platform, device, server, or other equipment in accordance with illustrative embodiments (see for example the devices, servers, systems, and equipment of FIG. 1). All or portions of the process of FIGS. 3-6 may be performed automatically. The process of FIG. 3 may be implemented by a system or platform, such as the system 100, data platform 120, or devices 101 of FIG. 1 referred to generically herein as the platform. In one embodiment, the platform may be integrated with a litigation management system, software, and/or services.

The steps of FIGS. 3-6 may be combined in any order, integrated, or otherwise combined as useful. In one embodiment, the user may give permission for various purchases to be stored and recorded for subsequent review and analysis. In other embodiments, the sellers of goods and services may perform documentation and tracking for logistic, liability, customer services, and legal reasons.

The process may begin by receiving user purchase data (step 300). The user may represent an individual, family, group, entity, corporation, or other party. In one embodiment, the purchase data may relate to products or services that the user has purchased, acquired, shared, integrated, or otherwise used. The purchase data may also represent any number of transactions (monetary or otherwise). In one embodiment, a user profile may be created for a new or distinct user for storing applicable data and information. In another embodiment, the data platform may track additional data, such as negligence, malpractice, defective/dangerous/faulty products and services, recalled products, failure to adequately warn of dangers or adverse effects involving products/drugs/services, ineffective product labeling, and other applicable information. In one embodiment, the purchase data may be filtered as received. For example, extraneous or inapplicable data may be removed from purchase data that may be subsequently saved. The purchase data may be alternatively referred to a user data and may be data and information that the user has consented to being tracked, saved, or otherwise recorded

Next, the platform documents the purchase data (step 302). In one embodiment, the purchase data may be added to a user profile associated with the data. The data profile may be created, updated, modified, and otherwise utilized over time. During step 302, the purchase data may be associated with one or more users and analyzed/processed to fully evaluate the data. For example, the identity of a user utilizing a device may be determined (e.g., historical selections, face recognition, biometrics, etc.) and associated with the information. During step 302, the purchase data may also be verified, confirmed, or otherwise vetted for validity, accuracy, and authenticity.

Next, the platform stores the purchase data as secure records (step 304). In one embodiment, the platform may store the purchase data associated with the user on a ledger associated with blockchain data. The purchase data may be securely stored so that it is not able to be retrieved by unauthorized parties, such as criminals, hackers, or others. In one example, the purchase data may be referenced by one or more blockchain tokens that includes a secure identifier pointing to the purchase data. For example, the purchase data may be stored in a server that requires an encrypted connection and the secure identifier for access with all access and utilization being documented and recorded as well. In another example, the blockchain token itself may encapsulate the purchase data. Any number of transactions involving the purchase data are contemplated.

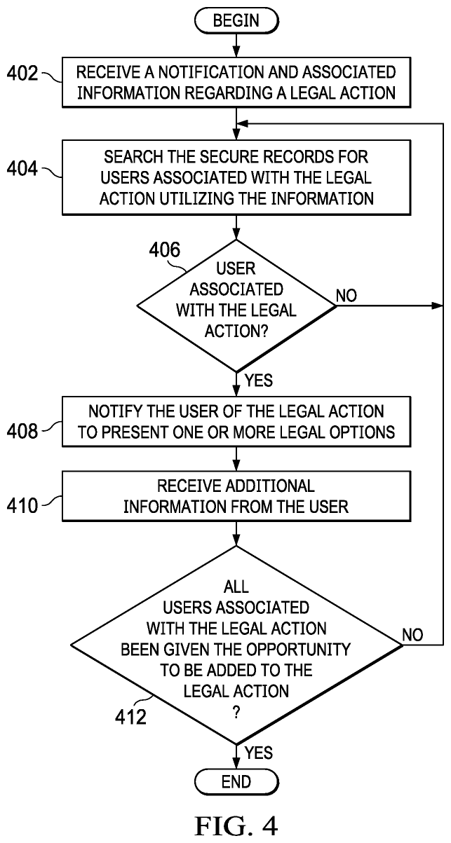

FIG. 4 is a flowchart of a process for adding users to a legal action in accordance with an illustrative embodiment. The legal action may include any number of class actions, tort litigations, government actions, and so forth. In one embodiment, the data platform may be performed for a legal action or other actions, such as accounting, financial, communication, advertisement, marketing, or other large-scale action.

The process of FIG. 4 may begin by receiving a notification and associated information regarding a legal action (step 402). In one embodiment, the notification indicates that there is a class-action lawsuit, mass tort litigation, product liability case, governmental concern, accounting matter, financial issue, or other action, case, or matter. For example, the notification may indicate that an applicable legal matter has been initiated. The associated information may specify the potentially affected individuals, groups, parties, or so forth. The associated information may also specify the goods, products (e.g., consumer products, medical devices, vehicles, drugs/medications, commercial products, etc.), services, or so forth. For example, the process of step 402 may be initiated as part of preliminary or ongoing class action matter, litigation, legal proceeding, or so forth.

Next, the platform searches the secure records for users associated with the legal action utilizing the information (step 404). The platform may perform any number of database queries, Internet searches, electronic searching, or so forth. The platform may perform the searching of the secure records itself or may utilize outside devices or services specialized for searching the secure records. The platform may utilize tokens, virtual private networks, encrypted communications, secure identifiers, secure sessions, and other processes to ensure that the records and associated information and data are securely accessed and managed. In one embodiment, the platform is securely searched to ensure the privacy and security of users and their information. During step 404 numerous potential plaintiffs, claimants, defendants, injured parties, relevant parties, or others are searched for and identified.

Next, the platform determines whether the user is associated with the legal action (step 406). If the user is not associated with the legal action, the platform returns to search the secure records for users associated with the legal action utilizing the information (step 404). The platform may determine whether the user's purchases, actions, or other activities are associated with the legal action. For example, the secure purchase records of the user may be recorded. The users may be identified securely so that the identification and privacy of the users is maintained. For example, the user may be identified utilizing a numeric code, pseudonym, key, or other information that prevents relevant user information from being retrieved by hackers, criminals, opposing parties/counsel, or other parties.

Next, the platform notifies the user of the legal action to present one or more legal options (step 408). As previously described, the legal action may represent any number of large-scale or small legal matters, cases, procedures, suits, or actions. The notification may be performed by the platform through an email, text message, in-application message, certified mail, or other form of electronic or in person communication. As previously noted, the platform may automatically send the messages without user input or in response to user input. The user may be presented with any number of legal options including one or more of joining the legal action, asserting rights, providing a testimony, facts, affidavit, or other information, declining representation, declining participation in the legal action, or any number of other options.

Next, the platform receives additional information from the user (step 410). In one embodiment, the additional information may be associated with the one or more legal options that are presented in step 408. For example, a corresponding selection may be received from the user. The platform may receive additional information and/or one or more selections utilizing a secure and certified process of information and selections associated with the user. Communications may also be received through surveys, legally binding input or selections, in-application communications, and/or other forms of communication. The additional information and selections may also be received from a lead plaintiff, lead defendant, litigation manager, class action representative, applicable legal counsel, or other authorized parties. The additional information may also represent details or information required for the user to proceed as part of the legal action. For example, the additional information may represent a legal name, address, sex, age, purchased product/service, relevant date(s) for the product/service, legal preferences/selections, compensation preferences, and other applicable information. In one embodiment, the additional information is received in response to a solicitation or request from the platform to the user. The solicitation may be general or may require specific, documented, or authenticated information.

The user may also be added to the legal action as additional information is received. The user may select to be a client, plaintiff, defendant, claimant, or other party to the legal action. The process of adding, removing, or modifying users may be binding upon the user as various legal rights may be incorporated in the decision.

Next, the platform determines whether all users associated with the legal action have been given the opportunity to be added to the legal action (step 412). In one embodiment, the platform may perform analysis of the products/services and users that may be potentially involved. The platform may analyze and process data and information across a number of services, storages, platforms, equipment, networks, systems, devices, and so forth. In some cases, various thresholds or requirements must be met before the legal action may move forward. For example, the notification process of step 408 may be performed a number of times to ensure that all of the potential users have received ample opportunity to join the legal action or otherwise actively select how to proceed. In addition, different resources and searches may be performed iteratively or responsively to ensure that all associated users are found and presented with applicable legal options.

In response to determining all users associated with the legal action have been given the opportunity to be added to the legal action, the process terminates. If the platform determines all users associated with the legal action have not been given the opportunity to be added to the legal action in step 412, the platform returns to search the secure records for users associated with the legal action utilizing the information (step 404). The platform may utilize machine learning and artificial intelligence to improve the process of finding potential participants in the legal action. For example, the platform may determine that specific demographics or regions are more associated with users that become active participants in the legal action and may then focus resources on those demographics and regions.

In another embodiment, the legal action may be continued, initiated, completely adjudicated, settled, or may otherwise move forward to resolution, termination, settlement, or so forth. For example, once all of the applicable class participants are presented with litigation information, the class action may move forward.

Various alternative embodiments of the various processes and methods may also be implemented. For example, before performing any of the processes herein described a program or application communication with the data management platform may be installed. For example, an application program interface (API) may be installed or integrated with any number of platforms, programs, or so forth. Any number of software programs, scripts, modules, or other sets of instructions may also be stored, installed, or executed to perform the methods herein described. The API may be integrated with a web browser as an add-in, extension, or other interface. For example, the API may be integrated with a search tool (e.g., standalone, browser-based, network managed, etc.). The API may be utilized by law firms, legal groups, individuals, corporations, data exchange companies to effectively initiate, implement, and manage legal actions. The illustrative embodiments are an improvement over existing technologies because they provide automated methods of finding parties/plaintiffs that may need to have their rights adjudicated, receive legal notices or communications, or otherwise participate in a legal, commercial, or other process authorized by the respective country.

The platform may also receive or update a user profile at any time. The user profile may represent an individual, family, group of individuals (e.g., friends, clubs, associates, etc.), company, organization, or entity and may be referred to generally as a “user profile” or “data profile.” For example, a user profile may be created for a user. The data profile may also include user preferences, settings, parameters, and other applicable information that control what, when, and how data may be collected, shared, monetized, and otherwise utilized. The user profile may be generated or determined from already available information for the user. For example, the user profile may represent one or more profiles compiled by devices, accounts, services, questionnaires, forms, biding statements or affidavits, or so forth. The user may provide answers utilizing one or more surveys, fields, questions, or other applicable information and data to determine applicable information and data. For example, the user may provide information regarding transactions of goods and services that have been purchased that are not easily tracked using any methodology.

The platform may process data from numerous users simultaneously, concurrently, or as generated. The data may be processed by adding, confirming, modifying, reconfirming, and authorizing data according to the user profile. In one embodiment, raw data may be converted into data objects. For example, user purchases may be created to specify that the user has infant and purchased a specific make and model of crib. As a result, if there is a legal action (e.g., product recall, class action litigation, etc.), the user may be contacted regarding the purchase of the crib to properly protect the user and his/her children and associated legal rights. The illustrative embodiments may utilize artificial intelligence or machine learning to perform processing and segmentation of the data during the data collection process. The data may be raw, partially processed, structured, or unstructured as utilized and monetized. The data herein described may be transformed from raw data into data objects, sets, and profiles tied to real world and digital assets.

The data may be associated with a unique security token that points to or includes the data. The data may include new, added, modified, or updated user data or profile objects, such as consumer interest, sharing of personal plans, likes and dislikes, opinions, social media feeds, purchases, preferred retailers, products and services of interest, and other similar information.

The platform may vend the data for searches, management, communications, reviews, acquisition, research, or so forth. For example, a law firm may pay the data platform to search the data for potential plaintiffs, defendants, interested or injured parties, experts, or so forth. The tokens may grant access to the data. Full or partial tokens may be included in transactions. The tokens may be involved in transactions by advertisers, brands, corporations, and any entity who values or requires access to the data. Tokens may be passed from these parties to consumers/users in exchange for access to their data. The tokens may be distributed each time a user associated with a data object directly or indirectly participates in accessing, sharing, updating, exchanging, managing, utilizing, monetizing, or selling the data. The illustrative embodiments provide the ability to band multiple variable priced micro fractions of tokens for each single or new data point/object. The platform may also band a single higher value token to represent and monetize a large exchange of data (e.g., objects, sets, profiles, pool(s), etc.).

Next, the system monetizes the data for the benefit of individual users, data platform service providers, legal groups, and others. The platform may track the fluctuating value of the data points, sets, and pools (all referred to as “data”). The system may ensure that users receive optimal compensation and monetization of their data while providing benefits to authorized users (e.g., government groups, law firms, companies, etc.). User may be paid in hard currency (e.g., American Dollars, British Pounds, Mexican Pesos, etc.), digital currency, discounts, services, rebates, or so forth. The purchasers, renters, or accessors of the tokens/and associated data may offer users micro fractions of a tokens market value in exchange for access to the data. The illustrative embodiments may provide a method of utilizing data that satisfies user, legal/privacy, and industry standards as well as securing the data against unwanted access or intrusions.

The data may be received as data elements. One or more data elements may be received in a session, simultaneously, sequentially, or concurrently. The data element may be received through any number of processes, devices, platforms, or so forth. For example, the data elements may be received through online, application, or electronic purchases, video selections, point-of-sale, foot traffic, location, surveys, social media selections, web consumption and history, audio input, and so forth. The platform may also verify the data elements individually or as part of a data set. The verification may also be performed utilizing input or feedback from the user. All of the processes of FIGS. 3-4 may be performed automatically by algorithms, programs, or instructions configured to accomplish specified tasks. The platform may also confirm that the data is applicable to the user. The platform may also receive specific user input to confirm that data belongs to the user or originated from the user or their authorized activities. For example, the user may verify that the data element is accurate and resulted from actions, activities, transactions, selections, or data of the user. In another example, the user may determine that the data element was not received utilizing approved methods or processes. As a result, the data element may be deleted or otherwise removed. The data element may not be incorporated into a larger data set or a data profile associated with the user. The user maintains control over their data and how it is captured, managed, monetized, and otherwise utilized by themselves and third parties.

The data may be tokenized via block chain for the purposes of authorizing, securing, searching, managing, processing, analyzing, confirming, valuing, and monetizing data elements (both consumer and commercial). Data validation and authentication may be performed at any time. In one embodiment, the platform may ensure that the data was received from the user. As is well known, in families and other groups, many users may individually access different wireless and computing devices. For example, devices such as tablets, smart phones, laptops, personal computers, gaming devices, electronic readers, and so forth may be utilized by a number of users. The platform may verify the user associated with the data or utilize machine learning or artificial intelligence to make assumptions. In one example, as data is received, the user may ask a verification question, such as “is this Blair?” The platform may also utilize machine learning to recognize activities, programs, and behavior associated with each of a number of users that may utilize the electronic devices that are part of or in communication with the platform. For example, particular websites or applications or activities may be associated with a particular user and correspondingly documented. The platform may also receive confirmation from the user. Any number of processes may be utilized to perform confirmation. For example, user opt ins, surveys, codes/passwords/pins, biometrics recognition (e.g., facial recognition, fingerprints, etc.), buttons/interface selections, feedback, user input, and other active or passive selections may be utilized to receive confirmation from the user. The confirmations and verifications may also be utilized to add the user as a participant/plaintiff of a legal action. For example, through the confirmation and verification process, the user may be added as a participating plaintiff in a class action litigation and agree to the legalities of participating as a member of the class. The platform may determine if the data set is complete. The platform may compare the data set to other data sets or digital profiles to look for missing, incomplete, or shared data elements or data sets. The platform may receive additional data as automatically searched out or received from the user.

The platform may also receive instructions from the user specifying how their data may be used. The user may specify how, when, and where their data elements, compiled data sets, and data profile may be utilized. For example, the granular level of authorization may include individual applications, companies, organizations, entities, and others that may access the data. The platform may receive compensation for sharing tokenized data sets with interested parties. The platform monetizes the data to ensure that the user, data platform service provider, and other applicable parties are compensated for the receipt, analysis, processing, and utilization of the data. The user may elect not to receive earnings, payments, or the monetary benefit of the data being monetized. For example, the earnings (e.g., dollars, crypto the, points, credit, discounts, etc.) may be allocated, donated, shared, or otherwise distributed to charitable groups, organizations, and individuals, injured or aggrieved parties, and so forth.

The platform may also determine relevance of the data to one or more interested parties. For example, a law firm may request information regarding potential purchases of a specified type of medical service from 2019-2029. The platform may perform searches based on specified fields, forms, or data to generate results. The law firm may be notified of the numbers of individuals and other information before deciding whether paying to purchase the data. If the law firm and service provider come to an agreement regarding the price of the data, a payment transaction may be completed. The platform and/or users may be compensated for access to the aggregated data.

During any of the processes, data (unstructured or structured) may be created, added, confirmed, modified, authorized, and verified. At any time, different data objects may be added. The data may be added as individual elements, sets, profiles, and pools.

Tokens may be created for one or more data sets as needed. The tokens may point to a single data object/element, data sets, data profiles, or data pools. The illustrative embodiments allow for the tokenization of a real-world or digital asset for the purpose of implementing micro-fraction ownership of the corresponding asset. The tokens may then be involved in any number of transactions involving numerous parties. In one example, the data is stored in a secure and encrypted hash on a block chain (step 404). An encrypted hash on the blockchain may be utilized to store the data (e.g., data objects, data sets, data pools, etc.). Although reference is made to utilizing a block chain system, the illustrative embodiments may also utilize other secure storage techniques, such as encrypted databases, secured servers, and so forth.

In one embodiment, the usage of data may be controlled utilizing one or more contracts, such as engagement letters, form contracts, custom agreements, settlement agreements, court orders, smart contracts, or so forth. A smart contract is a computer program, logic, or set of instructions that directly controls the transfer of digital currencies or assets between parties under certain conditions. The smart contract may also be referred to as a cryptocontract. A smart contract may be utilized to control utilization of the data. The smart contract may be created based on the requirements of the user and potential purchasers/users (e.g., law firms, corporations, etc.). The smart contract governs how the data may be utilized and how the user may be compensated for transactions involving the data. The smart contract may also specify the rights granted to a token holder. The legal rights, permissions, binding terms, and other information may be specified by the smart contract. In one embodiment, the smart contract controls how the data is utilized and monetized. The price of the data may be governed by free market valuations. Alternatively, the smart contract may set price maximums and minimums. In one embodiment, the smart contract may allow for the geographic utilization of the data. For example, the data may be of value for location or action based legal actions.

Transactions may be performed for all or portions of a token. The platform may include or represent an exchange. As noted, full tokens or partial tokens of any size may be involved in transactions. For example, fractional or micro share of the tokens may be involved in the transactions. The purchase or exchange of tokens may provide a party access to the data associated with the token. Transactions may be performed through the system that values the tokens, data, and other transaction components in real-time. The transaction may include any number of market, limit, stop, short, option, or futures transactions or orders. For example, the transaction may be performed based on a price that is predetermined or determined in real-time.

The platform may also document the transactions in the block chain. In one embodiment, the transaction may be recorded on the ledger associated with the block chain. The transaction may also be recorded utilizing any number of databases or so forth. Any number of time stamps, authentication codes, identifiers, users, types of transactions, locations, and other applicable information may be documented. The platform may also enforce the monetization of the data involved in the transaction. In one embodiment, the monetization of the data and associated transaction involved in the transaction may be governed by the smart contract.

The illustrative embodiments may be utilized to create corporate and consumer data estates. Corporation, entity, group, family, or user may be tokenized as a data estate. The data grouping of the estate may include each data profile element with a single profile and corporation data profile, groups of data profiles, and token-based micro shares tied to data points, data objects, data sets, data pools, and data estates. Artificial intelligence may be utilized to verify the data is current and complete. The single and groups of data profiles may be ranked by value and desirability. Data estates may be similarly involved in transactions and legal actions as is herein described.

The decentralized nature of the illustrative embodiments including utilization of block chain technology may allow any currency to be exchanged for access to data. As a result, the existing methods of communication and implementing large scale legal actions may become obsolete. Many of these models are ineffective and costly to corporations or groups that purchase or access the data. The illustrative embodiments focus on data completeness by motivating users to provide accurate and real time data for enhanced protection of their legal rights and interests. The value provided by the data refinery, data vault, and data exchange may lead to higher participation rights in the judicial process, enhanced safety, and better adjudication of individual's rights and privileges.

The data valuation and monetization system and methods herein described are also disruptive because they give data and data profile owners visibility and control over which companies, groups, entities, or individuals are authorized to access their data and which parties are blocked access. For example, a white list and a blacklist may be utilized to specify the parties that have full, limited, or no access to the data. As a result, blocked parties are prevented from participating in any transactions for tokens/data for which they are unauthorized.

The illustrative embodiments provide a methodology to define and value user data by measuring user engagement and data verification, date profile completeness, profile data point saturation, data point marketability, data point desirability and market specific data. The platform may also indicate that specific data has become less or more desirable and may indicate when data is static, non-static, ever changing or perennial, or less desirable through the utilization of the data platform and data marketplace.

In the illustrative embodiments, token purchases and payouts may be documented in smart contracts. The smart contracts may be executed by users and parties (e.g., advertisers, marketers, analysts, researchers, etc.) who trade access to the data for a full or partial share of the token. Tokens may be exchanged between parties based on needs and desires. The data may be valued based on how often it is updated, modified, verified, and based on overall completeness and accuracy.

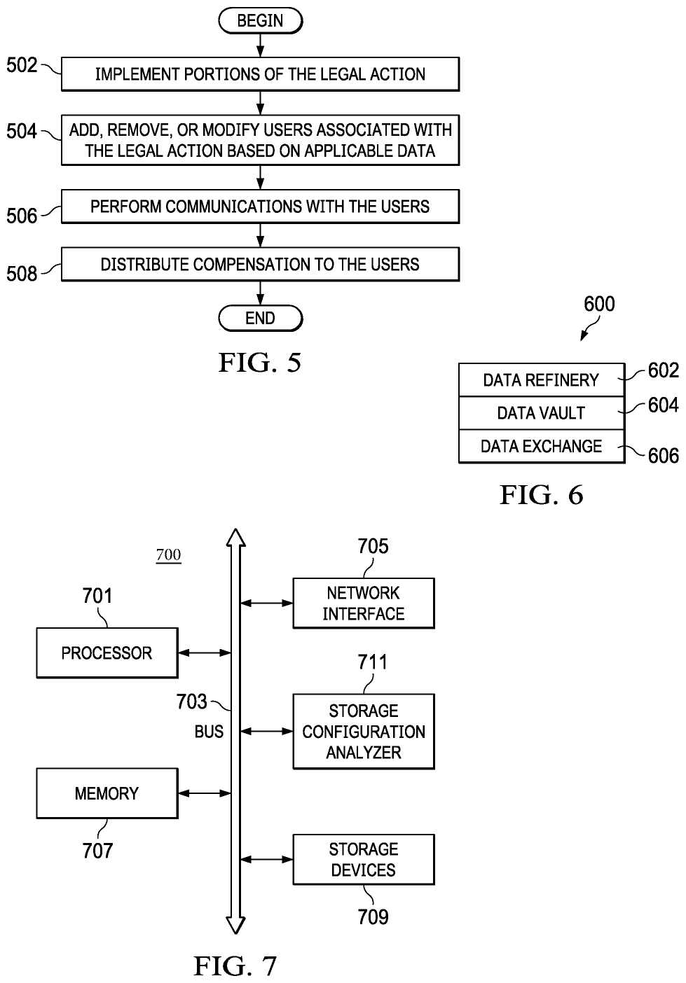

FIG. 5 is a flowchart of a process for implementing a legal action in accordance with illustrative embodiments. The process of FIG. 5 may be implemented or interchangeable with any of the steps of FIG. 4. The process may begin by implementing portions of the legal action (step 502). For example, portions of the legal action may include the pleadings, complaint or amended complaints, motions, answers to the motions, discovery (e.g., admissions, interrogatories, depositions, etc.), negotiations, trial, appeals, enforcement/compensation, and any other portions of the suit (including before, during, and after). The data platform may be utilized as part of the legal process to further document the actions of the parties to the legal action and the associated clients/users.

Next, the data platform adds, removes, or modifies users associated with the legal action based on applicable data (step 504). The applicable data may represent the additional information, research, analysis, transaction data, authenticated data, or other information and data. The users may represent clients, plaintiffs, defendants, litigants, claimants, lawyers, or other interested parties. The interests, rights, and status of the users may change based on the legal action and the associated process. For example, some products may be removed from a class-action litigation and users that purchased only those products may also be removed.

Next, the data platform performs communications with the users (step 506). Communications with the users may be performed as legally required or based on user preferences to receive applicable information. Any number of communications may be performed during the legal action. The communications may require legally binding and documented decisions, selections, agreements, consent, approval, denials, and so forth. As a result, the communications may be documented in a blockchain format. The data may be encrypted or otherwise secured to apply with applicable laws regarding privacy, securities, and so forth.

Next, data platform distributes compensation to the users (step 508). The compensation may include money (e.g., cash, checks, direct deposit, etc.), blockchain tokens, coupons, discounts, free product, free services, or so forth. The compensation may be distributed utilizing any number of mediums. In other embodiments, the verdict, judgement, public knowledge, press, or other aspect of the proceeding may serve as compensation.

Any number of preparatory steps may be performed as part of the processes of FIGS. 3-5. For example, a user profile may be created for a user. The user profile may be generated or determined from already available information for the user. For example, the user profile may represent one or more profiles compiled by devices, accounts, services, or so forth. The user may provide answers utilizing one or more surveys, fields, questions, or other applicable information and data to determine applicable information and data.

The process of FIGS. 3-5 may be performed automatically by algorithms, programs, or instructions configured to determine the validity and authenticity of data components. The user may specify preferences for controlling how and when the data is utilized. For example, a granular level of authorization may include individual applications, companies, organizations, entities, and other permissions regarding who may access the data.

The illustrative embodiments provide enhanced methods for user inclusion in legal actions including mass tort litigation, class action lawsuits, product recalls, and so forth. As a result, both users and consumers may reduce their liabilities and costs. For example, the platform may utilize blockchain to provide a service for identifying, classifying, tracking monitoring, valuing, and monetizing data and class action lawsuit outcomes. Unique consumer and corporate tracking methodologies may be utilized to document, track, and alert platform members to each new legal action as well as providing them legitimate options and opportunities. For example, dangerous or defective products may be more effectively tracked along a product supply line or distribution channels. Parties that pursue or defend legal actions may also be able to more efficiently and effectively implement the legal actions with enhanced methods of discovering parties to the litigation, case management, communication, and award distribution.

The data platform helps companies who act as third-party sellers, retailers, service providers, hospitals, corporations, distributors, wholesalers, or other industries where there is a pass-off of goods or services by providing an added layer of protection when those goods or services become subject to a lawsuit. In the past tracking down stream or secondary transactions were very difficult for the original producer of goods or services or those parties that are liable for any related issues.

FIG. 6 is a pictorial representation of a platform 600 for managing data in accordance with an illustrative embodiment. The platform 600 may also be referred to as a data platform and may include a data refinery 602, a data vault 604, and a data exchange 606. The platform 600 of FIG. 6 may be representative of one or more devices, such as the servers 116, data platform of FIG. 1, or other smart networked device implementing specific hardware, software, firmware, and/or sets of instructions. The platform 600 including the data refinery 602, data vault 604, and the data exchange 606 may function as separate platforms or an integrated platform. The platform 600 may be utilized to document user data and transactions, managing legal actions (e.g., search for potential plaintiffs/injured parties, send legal notices, manage legal notices, implement legal and smart contracts, receive user selections, etc.)

The data refinery 602 is utilized to create data objects and capture applicable data to include the data objects. For example, an individual transaction may represent a data object or data element. In one embodiment, the data refinery 602 may be positioned within the user's existing system to capture data that is already received, entered, gleaned, or otherwise determined by the existing system. The data object may be created to store all, portions, or types of data associated with the user (e.g., individual, couple, family, company, organization, group, entity, etc.). Transaction data for purchases, leases, or utilization of goods and services is given as an example of one potential data object.

The data vault 604 is utilized to securely store the data objects and add, modify, and improve the associated data. In one embodiment, the data vault may be utilized to collect, characterize, and value the data. The data vault 604 may also determine the pace at which new data objects are added or updated as well as the types of data. For example, the data vault 604 may determine that information relevant to two of the user's clients including company preferences for wireless services and legal services are added to the data vault 604 each day. The data vault 604 may be a physical or virtual storage and vault that securely stores information. In one embodiment, the data objects may be deidentified to remove identifying information to prevent hacking, identity theft, and other unwanted or prohibited utilization of data. The data vault 604 may also assign an initial value for the data object. The value may be associated with similar data, going rates, completeness of the data, the type of data, the user supplying the data, historical information, and so forth. The value may change at any time based on a determination of the platform 604 (i.e., the data vault or data exchange).

The data exchange 606 is utilized to price and perform transactions for the data objects. In one embodiment, the data exchange 606 creates a ticker associated with the data object. The ticker may be associated with the data object(s) for a user. The data exchange 606 allows the data objects to be priced and purchased. In one embodiment, exchange may utilize secure tokens to access the data. For example, transactions involving the data may represent a key for accessing the purchased or leased data. For example, the cryptocurrency tokens may include a hash key, encryption key, password, biometric, or other secure identifier for accessing the data object from the data vault or other stored location.

The platform 600 may perform data reconciliation of the information at any time during the process. In one embodiment, a data reconciliation engine may review the applicable information to determine products/services that align with pending legal actions. In one embodiment, the platform 600 may determine a portfolio of potential plaintiffs for a class action lawsuit by analyzing thousands or millions of user's data or interests. As a result, the actionable data may be readily available in real-time or near real-time.

Likewise, at any time the platform may create targeted legal advertisements or notices based on the user data. The targeted notices, alerts, messages, advertisements, or marketing may represent any number of communications displayed to the user including Internet advertisements, in-application advertisements, television/video/Internet Protocol Television advertisements, radio/Internet radio, print advertisements, and other forms of advertisements and marketing.

In one embodiment, advertising and marketing may be directed toward the user in response to a selection made by the user to opt-in to targeted advertisements that benefit the user's interests rather than random advertisements. For example, the selection may involve the acceptance of financial or legal language utilizing a graphical user interface presented utilizing a web interface, mobile application, or so forth. The selection may be to receive targeted advertisements rather than generic advertisements or advertisements that are not associated with the user's data and interests. In one embodiment, a profile associated with the platform may specify the companies, organizations, entities, or other groups that the user would like to support. The user's profile may also include any number of settings, configurations, parameters, selections, releases, authorizations, verification requirements, or other information and data that controls how the user's data is utilized in accordance with the illustrative embodiments. The user referenced herein may also refer to one or more individuals, a group of people, an entity, an organization, associated persons, or so forth. The data may also be referred to as personal data, consumer data, private data, monetized data, authorized data, advertising data, or marketing data and may include individual data units, data sets, data pools, and other amalgamations or compilations of data, values, and information. The illustrative embodiments utilize blockchain and tokens because of the need for enhanced confidentiality and performance of data transactions.

The illustrative embodiments allow blocks of user data, litigation data, vending data, transaction data, and other data and information described herein to be stored across a blockchain system, platform, or network. There is no single point of failure. User's data is secured so that access and utilization results in efficient, fair, and legitimate legal actions in a way that has not happened before. The user, service providers, sellers, intermediaries, exchanges, platforms, managers, and/or other parties or devices may perform create, read, update, and delete operations on the data with an audit trail of the user data and utilization being tracked. As a result, validation and reconciliation of all portions of the process may be performed effectively.

The illustrative embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible or non-transitory medium of expression having computer usable program code embodied in the medium. The described embodiments may be provided as a computer program product, or software, that may include a machine-readable medium having stored thereon instructions, which may be used to program a computing system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications mediums.

Computer program code for carrying out operations of the embodiments may be written in any combination of one or more programming languages, including an object-oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (e.g., through the Internet using an Internet Service Provider).

FIG. 7 depicts a computing system 700 in accordance with an illustrative embodiment. For example, the computing system 700 may represent a device, such as one or more of the devices 101 of FIG. 1. The computing system 700 includes a processor 701 (possibly including multiple processors, multiple cores, multiple nodes, and/or implementing multi-threading, etc.). The computing system includes memory 707. The memory 707 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computing system also includes a bus 703 (e.g., PCI, ISA, PCI-Express, HyperTransport®, InfiniBand®, NuBus, etc.), a network interface 705 (e.g., an ATM interface, an Ethernet interface, a Frame Relay interface, SONET interface, wireless interface, etc.), and a storage device(s) 709 (e.g., optical storage, magnetic storage, etc.). The system memory 707 embodies functionality to implement embodiments described above. The system memory 707 may include one or more functionalities that store user data (including transactions), content, blockchain data, tokens, ledgers, parameters, application, user profiles, and so forth. Code may be implemented in any of the other devices of the computing system 700. Any one of these functionalities may be partially (or entirely) implemented in hardware and/or on the processing unit 701. For example, the functionality may be implemented with an application specific integrated circuit, in logic implemented in the processing unit 701, in a co-processor on a peripheral device or card, etc. Further, realizations may include fewer or additional components not illustrated in FIG. 7 (e.g., video cards, audio cards, additional network interfaces, peripheral devices, etc.). The processor unit 701, the storage device(s) 709, and the network interface 705 are coupled to the bus 703. Although illustrated as being coupled to the bus 703, the memory 707 may be coupled to the processor unit 701.

The features, steps, and components of the illustrative embodiments may be combined in any number of ways and are not limited specifically to those described. In particular, the illustrative embodiments contemplate numerous variations in the smart devices and communications described. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes or methods of the invention. It is understood that any other modifications, substitutions, and/or additions may be made, which are within the intended spirit and scope of the disclosure. For the foregoing, it can be seen that the disclosure accomplishes at least all of the intended objectives.

The previous detailed description is of a small number of embodiments for implementing the invention and is not intended to be limiting in scope. The following claims set forth a number of the embodiments of the invention disclosed with greater particularity.

What is claimed is:

1. A method for managing a legal action, comprising:
receiving purchase data for goods and services associated with one or more users;
automatically storing the purchase data as secure records in a data platform;
receiving a notification and associated information regarding the legal action based on the purchase data;
automatically searching the secure records of a data platform for the one or more users associated with the legal action utilizing the information; and
communicating with the user of the legal action one or more legal options in response to determining the one or more users are associated with the legal action.

2. The method of claim 1, wherein the secure records are stored in a digital ledger accessible through one or more cryptocurrency tokens.

3. The method of claim 1, further comprising:
requesting additional information from the one or more users;
receiving additional information from the one or more users, wherein the additional information includes selections from a user for participating in the legal action.

4. The method of claim 1, further comprising:
creating one or more tokens based on the data type and value of purchase data;
vending the purchase data to one of a plurality of parties utilizing one or more tokens, wherein the user data is accessible from the secure records utilizing an indicator included in the one or more tokens; and
compensating one or more parties for vending the purchase data.

5. The method of claim 1, wherein the one or more users are an individual, family, group, corporation, or entity.

6. The method of claim 1, wherein receiving the purchase data includes receiving one or more data elements initially and verifying the accuracy of one or more data elements.

7. The method of claim 1, wherein the purchase data is utilized according to a user profile associated with each of the one or more users.

8. The method of claim 2, wherein the transaction data is accessible utilizing an indicator associated with the cryptocurrency tokens.

9. The method of claim 1, further comprising:
creating a smart contract controlling utilization of the user data to perform the legal action.

10. The method of claim 1, further comprising:
managing the legal action utilizing the data platform.

11. A system for managing a legal action, comprising:
a plurality of electronic devices executing a data application, the data application is configured to capture transaction data associated with a user; and
a data platform accessible by the plurality of electronic devices executing the data application through one or more networks, wherein the data platform receives user purchase data for goods and services associated with one or more users, automatically stores the purchase data as secure records in a data platform, receives a notification and associated information regarding the legal action based on the purchase data, automatically searches the secure records of a data platform for users associated with the legal action utilizing the information, notifying the one or more users of the legal action and one or more legal options in response to determining the one or more users are associated with the legal action, and receiving additional information and selections from the user.

12. The system of claim 11, wherein the data and the legal action are managed according to user preferences set by each of the one or more users.

13. The system of claim 11, wherein the legal action is one or more of product recall, mass litigation, or class action lawsuit.

14. The system of claim 11, wherein the data platform manages communications with the one or more users regarding the legal action.

15. The system of claim 11, wherein a smart contract controls utilization of the transaction data by the data platform and legal rights of the one or more users with regard to the legal action.

16. A data platform, comprising:
a processor for executing a set of instructions;
a memory for storing the set of instructions, wherein the set of instructions are executed to:
receiving purchase data for goods and services associated with one or more users, automatically storing the purchase data as secure records in a data platform, receiving a notification and associated information regarding the legal action based on the purchase data, automatically searching the secure records of a data platform for the one or more users associated with the legal action utilizing the information, communicating with the user of the legal action and one or more legal options in response to determining the one or more users are associated with the legal action, and receiving additional information from the one or more users.

17. The data platform of claim 16, wherein the data and the legal action are managed according to user preferences set by the one or more users.

18. The data platform of claim 16, wherein the data platform manages communications with the one or more users regarding the legal action.

19. The data platform of claim 16, wherein the data is accessible through an indicator included in a cryptocurrency token.

20. The data platform of claim 16, wherein a smart contract controls utilization of the transaction data by the data platform and legal rights of the one or more users with regard to the legal action.
